(19) United States
(12) Patent Application Publication
(10) Pub. No.: US 2025/0004354 A1
(43) Pub. Date: Jan. 2, 2025

(54) EXTERNAL POWER AND/OR DATA DELIVERY TO AN IMAGE CAPTURE APPARATUS

(71) Applicant: GoPro, Inc., San Mateo, CA (US)

(72) Inventors: Matthew Craig Feddersen, Scotts Valley, CA (US); Joseph Tucker, Santa Cruz, CA (US); Nicholas Vitale, Foster City, CA (US)

(21) Appl. No.: 18/657,264

(22) Filed: May 7, 2024

Related U.S. Application Data
(60) Provisional application No. 63/524,358, filed on Jun. 30, 2023.

(51) Int. Cl. G03B 17/56; G03B 17/08

(52) U.S. Cl. CPC G03B 17/56; G03B 17/08; G03B 2217/002; G03B 2217/007

(57) ABSTRACT

An image capture system that includes an image capture apparatus and an external accessory that is configured for electrical connection to the image capture apparatus. The image capture apparatus includes a body and a door that is coupled to the body and which includes a first electrical interface. The external accessory includes a second electrical interface with a dynamic configuration, wherein the first electrical interface and the second electrical interface are configured for contact such that power and/or data are communicable between the image capture apparatus and the external accessory.

### CROSS-REFERENCE TO RELATED APPLICATION(S)

This application claims the benefit of and priority to U.S. Provisional Patent Application Ser. No. 63/524,358, filed Jun. 30, 2023, the entire contents of which are hereby incorporated by reference.

### TECHNICAL FIELD

The present disclosure relates to the delivery of power and/or data between an image capture apparatus and an external source. More specifically, the present disclosure relates to the delivery of power and/or data via an electrical interface that is integrated into a door of the image capture apparatus, which allows the image capture apparatus to be connected to the external source without opening, repositioning, or otherwise manipulating the door.

### BACKGROUND

Image capture apparatuses are used in a variety of applications (e.g., handheld cameras and video recorders, cell phones, drones, vehicles, etc.) and include one or more lenses (or other such optical elements) and one or more image sensors. The lens(es) capture content by receiving and focusing light, and the image sensor(s) convert the captured content into an electronic image signal that is processed by an image signal processor to generate an image. In some image capture apparatuses, the lens(es) and the image sensor(s) are integrated into a single unit, which is known as an ISLA.

Typically, power and/or data delivery is accomplished by connecting a cable or the like to a receptacle (e.g., a charging port) on the image capture apparatus. Often times, however, the receptacle is concealed beneath a movable door, hatch, or other such cover, which can create a cumbersome user experience.

An opportunity thus remains for enhancements in the delivery of power and/or data to an image capture apparatus that improve and simplify the user experience.

### SUMMARY

In one aspect of the present disclosure, an image capture apparatus is disclosed that includes a body and a door that is coupled to the body such that the door is movable between a closed position and an open position. The door includes an integrated electrical interface that is configured for connection to an external accessory such that power and/or data are deliverable between the image capture apparatus and the external accessory while the door is in the closed position.

In certain embodiments, the integrated electrical interface may include a static configuration.

In certain embodiments, the integrated electrical interface may include a dynamic configuration.

In certain embodiments, the integrated electrical interface may be reconfigurable between an expanded configuration and a collapsed configuration.

In another aspect of the present disclosure, an image capture system is disclosed that includes an image capture apparatus and an external accessory. The image capture apparatus includes a body and a door that is movably coupled to the body. The door includes a first electrical interface, and the external accessory includes a second electrical interface. The first electrical interface includes connector pads, and the second electrical interface includes connector pins that are configured for contact with the connector pads so as to electrically connect the image capture apparatus and the external accessory.

In certain embodiments, the connector pins may be resiliently reconfigurable between an expanded configuration and a collapsed configuration.

In certain embodiments, the external accessory may include a sealing member that is configured for engagement with the door such that, upon connection of the external accessory and the image capture apparatus, a watertight seal is formed therebetween that extends about the first electrical interface and the second electrical interface.

In another aspect of the present disclosure, an image capture system is disclosed that includes an image capture apparatus and an external accessory. The image capture apparatus includes a body and a door that is movably coupled to the body. The door includes a first electrical interface with a static configuration, and the external accessory includes a second electrical interface with a dynamic configuration, wherein the first electrical interface and the second electrical interface are configured for contact such that power and/or data are communicable between the image capture apparatus and the external accessory.

In certain embodiments, the second electrical interface may be reconfigurable between an expanded configuration and a collapsed configuration.

In certain embodiments, the second electrical interface may be biased towards the expanded configuration such that a biasing force is created in the second electrical interface upon connection of the external accessory to the image capture apparatus that maintains electrical connection of the first electrical interface and the second electrical interface while allowing for relative movement between the image capture apparatus and the external accessory.

In another aspect of the present disclosure, an image capture system is disclosed that includes an image capture apparatus and an external accessory that is configured for electrical connection to the image capture apparatus.

The image capture apparatus includes a body and a door that is coupled to the body.

The door includes: a door body; a carrier that is supported by the door body; connector pads that are supported by the carrier; a flexible printed circuit (FPC) assembly that is supported by the door body and which is in electrical communication with the connector pads; and a receptacle that is supported by the door body. The receptacle is in electrical communication with the FPC assembly and is configured to interface with a power source of the image capture apparatus.

The external accessory includes: a chassis; a printed circuit board (PCB) assembly that is supported by the chassis; and connector pins that are supported by the PCB assembly and which are configured for contact with the connector pads so as to electrically connect the image capture apparatus and the external accessory, thereby eliminating any need to reposition the door to transmit power and/or data between the image capture apparatus and the external accessory.

In certain embodiments, the connector pads may extend through the carrier.

In certain embodiments, the connector pads may include first ends that are positioned within the door body and which are in electrical communication with the FPC assembly and second ends that are exposed from the door body to facilitate contact with the connector pins.

In certain embodiments, the connector pads may be recessed into the door body so as not to extend beyond an outermost surface thereof.

In certain embodiments, the connector pins may be resiliently reconfigurable between an expanded configuration and a collapsed configuration.

In certain embodiments, the connector pins may be biased towards the expanded configuration.

In certain embodiments, the door may further include a sealing member that is supported by the door body so as to define a watertight internal chamber for the connector pads.

In certain embodiments, the external accessory may further include a receptacle that is in electrical communication with the PCB assembly to facilitate power and/or data communication into the external accessory.

In certain embodiments, the external accessory may include a sealing member that is configured for engagement with the door such that, upon connection of the external accessory and the image capture apparatus, a watertight seal is formed therebetween that extends about the connector pads and the connector pins.

In certain embodiments, the door and the external accessory may include corresponding magnetic members to facilitate proper alignment thereof.

In another aspect of the present disclosure, an image capture system is disclosed that includes an image capture apparatus and an external accessory that is configured for electrical connection to the image capture apparatus.

The image capture apparatus includes a body and a door that is coupled to the body and which includes a first electrical interface.

The external accessory includes a second electrical interface, wherein the first electrical interface and the second electrical interface are configured for contact to facilitate power and/or data transmission between the image capture apparatus and the external accessory.

In certain embodiments, the first electrical interface may include a dynamic configuration, and the second electrical interface may include a static configuration.

In certain embodiments, the first electrical interface may include a static configuration, and the second electrical interface may include a dynamic configuration.

In certain embodiments, the second electrical interface may be reconfigurable between an expanded configuration and a collapsed configuration.

In certain embodiments, the second electrical interface may be biased towards the expanded configuration.

In another aspect of the present disclosure, an image capture apparatus is disclosed that includes a body and a door that is coupled to the body. The door includes an electrical interface that is configured for connection to an external accessory to facilitate power and/or data transmission between the image capture apparatus and the external accessory.

In certain embodiments, the door may further include a door body and connector pads that are supported by the door body.

In certain embodiments, the connector pads may include first ends that are positioned within the door body and second ends that are exposed from the door body to facilitate connection to the external accessory.

In certain embodiments, the connector pads may be recessed into the door body so as not to extend beyond an outermost surface thereof.

In certain embodiments, the door may further include an FPC assembly that is supported by the door body and which is in electrical communication with the first ends of the connector pads.

In certain embodiments, the door may further include a receptacle that is supported by the door body and which is configured to interface with a power source of the image capture apparatus.

In certain embodiments, the receptacle may be in electrical communication with the FPC assembly.

### BRIEF DESCRIPTION OF THE DRAWINGS

The present disclosure is best understood from the following detailed description when read in conjunction with the accompanying drawings. According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIG. 4 is a block diagram of electronic components of an image capture apparatus.

FIG. 5 is a front, perspective view of another example of an image capture apparatus including a door that facilitates external power and/or data delivery to the image capture apparatus according to the principles of the present disclosure.

FIG. 6 is a partial, perspective view of the image capture apparatus seen in FIG. 5 shown with one embodiment of an external accessory that is configured for connection to the image capture apparatus in order to deliver power and/or data thereto.

FIG. 7 is a perspective view of the door seen in FIG. 5 shown with another embodiment of the external accessory seen in FIG. 6.

FIG. 8 is a partial, cross-sectional view of the image capture apparatus seen in FIG. 5.

FIG. 9 is an outer, perspective view of the door shown separated from the image capture apparatus seen in FIG. 5.

FIG. 10 is an inner, perspective view of the door shown separated from the image capture apparatus seen in FIG. 5.

FIG. 11 is a partial, inner, perspective view of the door shown separated from the image capture apparatus seen in FIG. 5.

FIG. 12 is an axial (longitudinal, vertical) cross-sectional view taken along line 12-12 in FIG. 9 and shown in perspective.

FIG. 13 is a partial, axial (longitudinal, vertical) cross-sectional view taken along line 13-13 in FIG. 6 and shown in perspective.

FIG. 14 is an axial (longitudinal, vertical) cross-sectional view of the door and the external accessory seen in FIG. 5.

FIG. 15 is an enlargement of the area of detail identified in FIG. 14.

### DETAILED DESCRIPTION

The present disclosure describes an image capture apparatus including a body and a door that is coupled to the body such that the door is movable between a closed position and an open position. The door includes a first electrical interface that is configured for connection to an external accessory such that power and/or data are deliverable (transmittable) between the image capture apparatus and the external accessory while the door is in the closed position. In order to facilitate such power and/or data delivery (transmission), the external accessory includes a second electrical interface that is configured in correspondence with the first electrical interface. More specifically, the first electrical interface includes connector pads, and the second electrical interface includes connector pins that are configured for contact with the connector pads.

In certain embodiments, it is envisioned that the connector pins may be resiliently reconfigurable between expanded and collapsed configurations such that a biasing force is created in the connector pins upon connection of the external accessory to the image capture apparatus that maintains electrical connection of the first and second electrical interfaces while allowing for relative movement between the image capture apparatus and the external accessory.

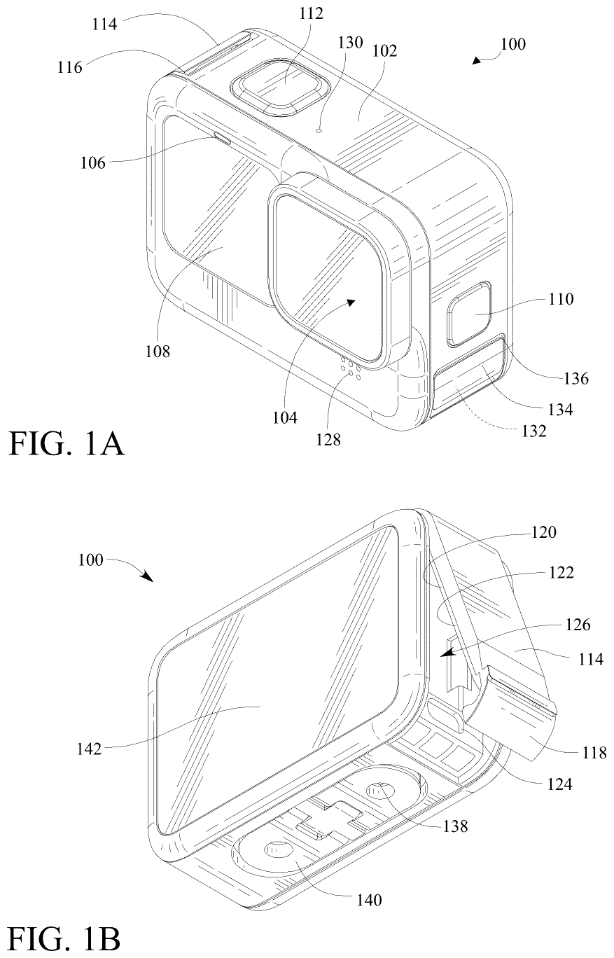

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured (connected) to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transmission between the battery and the image capture apparatus 100. In some implementations, the battery receptable 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is positioned (located) behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

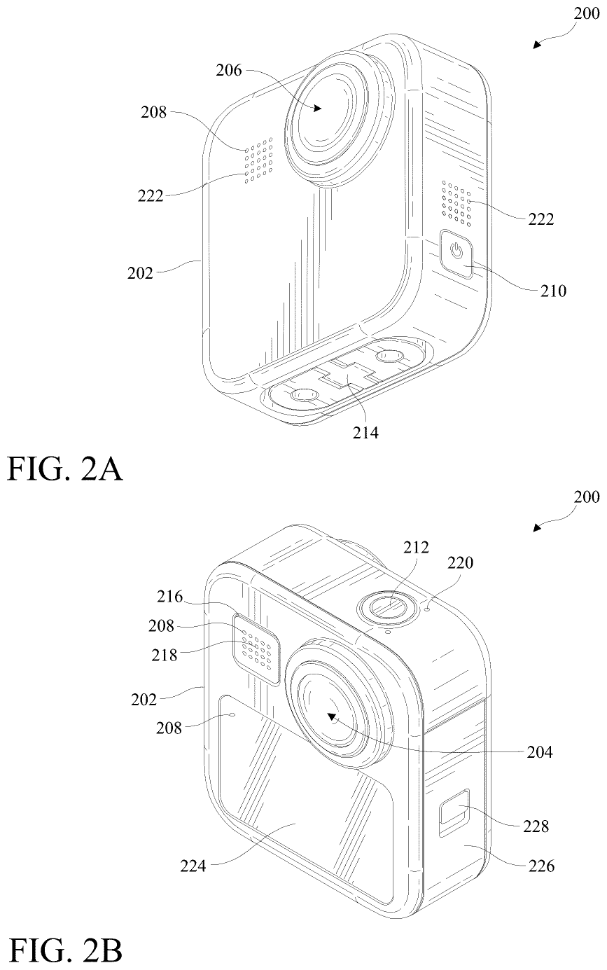

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

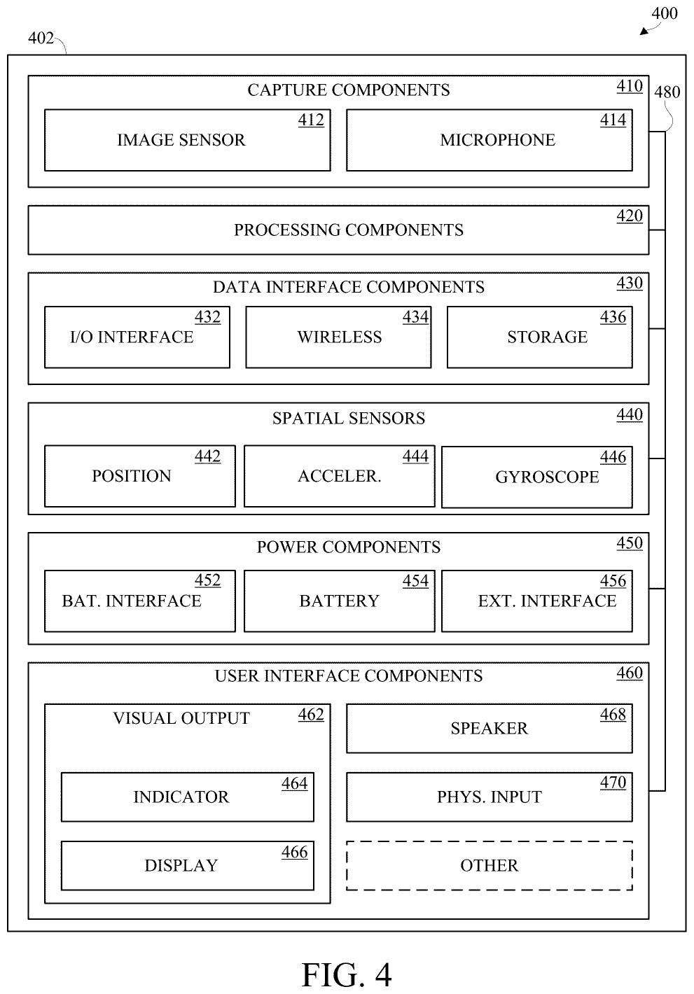

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 4.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is positioned (located) on a front surface of the body 202, a second audio component 220 is positioned (located) on a top surface of the body 202, and a third audio component 222 is positioned (located) on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

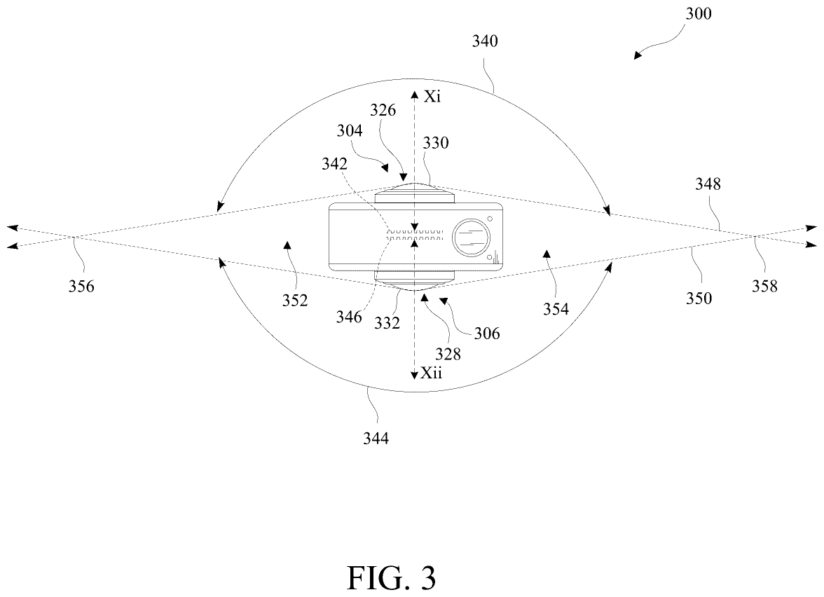

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342. In the illustrated embodiment, the first lens 330 and the first image sensor 342 are integrated into a single unit, whereby the first image capture device 304 is configured as a first ISLA 326 that defines a first optical axis Xi.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346. In the illustrated embodiment, the second lens 332 and the second image sensor 346 are integrated into a single unit, whereby the second image capture device 306 is configured as a second ISLA 328 that defines a second optical axis Xii.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions (e.g., a forward direction and a rearward direction), and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The ISLAs 326, 328 (e.g., the lenses 330, 332) may be aligned as shown (e.g., such that the optical axes Xi, Xii are coincident with each other), laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

FIG. 4 is a block diagram of electronic components in an image capture apparatus 400. The image capture apparatus 400 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-B, the image capture apparatus 200 shown in FIGS. 2A-B, or the image capture apparatus 300 shown in FIG. 3, may be implemented as shown in FIG. 4.

The image capture apparatus 400 includes a body 402. The body 402 may be similar to the body 102 shown in FIGS. 1A-1B or the body 202 shown in FIGS. 2A-2B. The body 402 includes electronic components such as capture components 410, processing components 420, data interface components 430, spatial sensors 440, power components 450, user interface components 460, and a bus 480.

The capture components 410 include an image sensor 412 for capturing images. Although one image sensor 412 is shown in FIG. 4, the capture components 410 may include multiple image sensors. The image sensor 412 may be similar to the image sensors 342, 346 shown in FIG. 3. The image sensor 412 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 412 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 412 captures detected light as image data and conveys the captured image data as electrical signals (image signals or image data) to the other components of the image capture apparatus 400, such as to the processing components 420, such as via the bus 480.

The capture components 410 include a microphone 414 for capturing audio. Although one microphone 414 is shown in FIG. 4, the capture components 410 may include multiple microphones. The microphone 414 detects and captures, or records, sound, such as sound waves incident upon the microphone 414. The microphone 414 may detect, capture, or record sound in conjunction with capturing images by the image sensor 412. The microphone 414 may detect sound to receive audible commands to control the image capture apparatus 400. The microphone 414 may be similar to the microphones 128, 130, 132 shown in FIGS. 1A-1B or the audio components 218, 220, 222 shown in FIGS. 2A-2B.

The processing components 420 perform image signal processing, such as filtering, tone mapping, or stitching, to generate, or obtain, processed images, or processed image data, based on image data obtained from the image sensor 412. The processing components 420 may include one or more processors having single or multiple processing cores. In some implementations, the processing components 420 may include, or may be, an application specific integrated circuit (ASIC) or a digital signal processor (DSP). For example, the processing components 420 may include a custom image signal processor. The processing components 420 conveys data, such as processed image data, with other components of the image capture apparatus 400 via the bus 480. In some implementations, the processing components 420 may include an encoder, such as an image or video encoder that may encode, decode, or both, the image data, such as for compression coding, transcoding, or a combination thereof.

Although not shown expressly in FIG. 4, the processing components 420 may include memory, such as a random-access memory (RAM) device, which may be non-transitory computer-readable memory. The memory of the processing components 420 may include executable instructions and data that can be accessed by the processing components 420.

The data interface components 430 communicates with other, such as external, electronic devices, such as a remote control, a smartphone, a tablet computer, a laptop computer, a desktop computer, or an external computer storage device. For example, the data interface components 430 may receive commands to operate the image capture apparatus 400. In another example, the data interface components 430 may transmit image data to transfer the image data to other electronic devices. The data interface components 430 may be configured for wired communication, wireless communication, or both. As shown, the data interface components 430 include an I/O interface 432, a wireless data interface 434, and a storage interface 436. In some implementations, one or more of the I/O interface 432, the wireless data interface 434, or the storage interface 436 may be omitted or combined.

The I/O interface 432 may send, receive, or both, wired electronic communications signals. For example, the I/O interface 432 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 432 is shown in FIG. 4, the data interface components 430 include multiple I/O interfaces. The I/O interface 432 may be similar to the data interface 124 shown in FIG. 1B.

The wireless data interface 434 may send, receive, or both, wireless electronic communications signals. The wireless data interface 434 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 434 is shown in FIG. 4, the data interface components 430 include multiple wireless data interfaces. The wireless data interface 434 may be similar to the data interface 124 shown in FIG. 1B.

The storage interface 436 may include a memory card connector, such as a memory card receptacle, configured to receive and operatively couple to a removable storage device, such as a memory card, and to transfer, such as read, write, or both, data between the image capture apparatus 400 and the memory card, such as for storing images, recorded audio, or both captured by the image capture apparatus 400 on the memory card. Although one storage interface 436 is shown in FIG. 4, the data interface components 430 include multiple storage interfaces. The storage interface 436 may be similar to the data interface 124 shown in FIG. 1B.

The spatial, or spatiotemporal, sensors 440 detect the spatial position, movement, or both, of the image capture apparatus 400. As shown in FIG. 4, the spatial sensors 440 include a position sensor 442, an accelerometer 444, and a gyroscope 446. The position sensor 442, which may be a global positioning system (GPS) sensor, may determine a geospatial position of the image capture apparatus 400, which may include obtaining, such as by receiving, temporal data, such as via a GPS signal. The accelerometer 444, which may be a three-axis accelerometer, may measure linear motion, linear acceleration, or both of the image capture apparatus 400. The gyroscope 446, which may be a three-axis gyroscope, may measure rotational motion, such as a rate of rotation, of the image capture apparatus 400. In some implementations, the spatial sensors 440 may include other types of spatial sensors. In some implementations, one or more of the position sensor 442, the accelerometer 444, and the gyroscope 446 may be omitted or combined.

The power components 450 distribute electrical power to the components of the image capture apparatus 400 for operating the image capture apparatus 400. As shown in FIG. 4, the power components 450 include a battery interface 452, a battery 454, and an external power interface 456 (ext. interface). The battery interface 452 (bat. interface) operatively couples to the battery 454, such as via conductive contacts to transfer power from the battery 454 to the other electronic components of the image capture apparatus 400. The battery interface 452 may be similar to the battery receptacle 126 shown in FIG. 1B. The external power interface 456 obtains or receives power from an external source, such as a wall plug or external battery, and distributes the power to the components of the image capture apparatus 400, which may include distributing power to the battery 454 via the battery interface 452 to charge the battery 454. Although one battery interface 452, one battery 454, and one external power interface 456 are shown in FIG. 4, any number of battery interfaces, batteries, and external power interfaces may be used. In some implementations, one or more of the battery interface 452, the battery 454, and the external power interface 456 may be omitted or combined. For example, in some implementations, the external interface 456 and the I/O interface 432 may be combined.

The user interface components 460 receive input, such as user input, from a user of the image capture apparatus 400, output, such as display or present, information to a user, or both receive input and output information, such as in accordance with user interaction with the image capture apparatus 400.

As shown in FIG. 4, the user interface components 460 include visual output components 462 to visually communicate information, such as to present captured images. As shown, the visual output components 462 include an indicator 464 and a display 466. The indicator 464 may be similar to the indicator 106 shown in FIG. 1A or the indicators 208 shown in FIGS. 2A-2B. The display 466 may be similar to the display 108 shown in FIG. 1A, the display 142 shown in FIG. 1B, or the display 224 shown in FIG. 2B. Although the visual output components 462 are shown in FIG. 4 as including one indicator 464, the visual output components 462 may include multiple indicators. Although the visual output components 462 are shown in FIG. 4 as including one display 466, the visual output components 462 may include multiple displays. In some implementations, one or more of the indicators 464 or the display 466 may be omitted or combined.

As shown in FIG. 4, the user interface components 460 include a speaker 468. The speaker 468 may be similar to the speaker 138 shown in FIG. 1B or the audio components 218, 220, 222 shown in FIGS. 2A-2B. Although one speaker 468 is shown in FIG. 4, the user interface components 460 may include multiple speakers. In some implementations, the speaker 468 may be omitted or combined with another component of the image capture apparatus 400, such as the microphone 414.

As shown in FIG. 4, the user interface components 460 include a physical input interface 470. The physical input interface 470 may be similar to the mode buttons 110, 210 shown in FIGS. 1A, 2A or the shutter buttons 112, 212 shown in FIGS. 1A, 2B. Although one physical input interface 470 is shown in FIG. 4, the user interface components 460 may include multiple physical input interfaces. In some implementations, the physical input interface 470 may be omitted or combined with another component of the image capture apparatus 400. The physical input interface 470 may be, for example, a button, a toggle, a switch, a dial, or a slider.

As shown in FIG. 4, the user interface components 460 include a broken line border box labeled “other” to indicate that components of the image capture apparatus 400 other than the components expressly shown as included in the user interface components 460 may be user interface components. For example, the microphone 414 may receive, or capture, and process audio signals to obtain input data, such as user input data corresponding to voice commands. In another example, the image sensor 412 may receive, or capture, and process image data to obtain input data, such as user input data corresponding to visible gesture commands. In another example, one or more of the spatial sensors 440, such as a combination of the accelerometer 444 and the gyroscope 446, may receive, or capture, and process motion data to obtain input data, such as user input data corresponding to motion gesture commands.

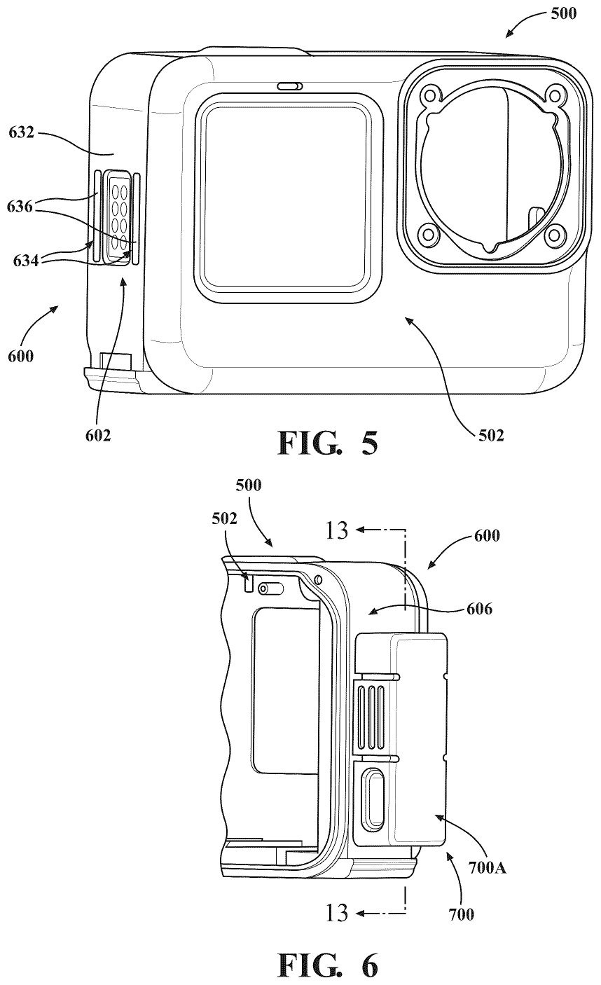

With reference now to FIG. 5, another image capture apparatus 500 is illustrated, which includes a door 600. The image capture apparatus 500 and the door 600 include components and features that are similar to the image capture apparatus 100 and the door 114 (FIGS. 1A, 1B) discussed above and, accordingly, will only be discussed with respect to differences therefrom in the interest of brevity. As such, identical reference characters will be utilized to refer to elements, structures, features, etc., common to the image capture apparatuses 100, 500 and the doors 114, 600. More specifically, FIG. 5 is a front, perspective view of the image capture apparatus 500 with the door 600 shown in the closed position.

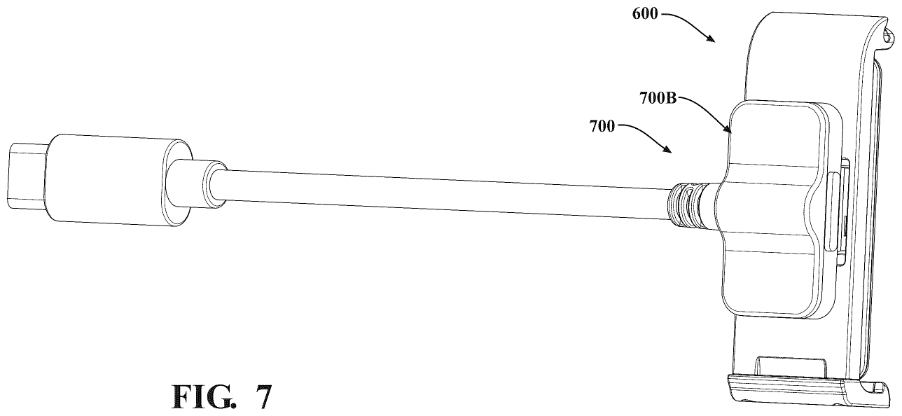

The door 600 is configured for (direct) electrical connection to an external accessory 700, which not only facilitates the transmission (delivery) of power and/or data between the image capture apparatus 500 and the external accessory 700, but allows for the incorporation of one or more additional (supplemental) features (e.g., GPS, an inertial measurement unit, a magnetometer, etc.). In order to support a wide variety of used cases, it is envisioned that the particular configuration of the external accessory 700 may be varied. For example, FIG. 6 is a partial, perspective view of the image capture apparatus 500 shown with one embodiment of the external accessory 700, which is configured as a power/data adapter (pack) 700A, and FIG. 7 is a perspective view of the door 600 shown with another embodiment of the external accessory 700, which is configured as a power/data cable 700B. Although not illustrated, embodiments in which the external accessory 700 may be configured as a docking station (e.g., to allow for charging of the image capture apparatus 500 after use) are also envisioned herein and would not be beyond the scope of the present disclosure.

As described in detail below, the configuration of the door 600 facilitates a direct interface between the image capture apparatus 500 and the external accessory 700 that eliminates the need to open, reposition, or otherwise manipulate the door 600 in order to transmit power and/or data between the image capture apparatus 500 and the external accessory 700.

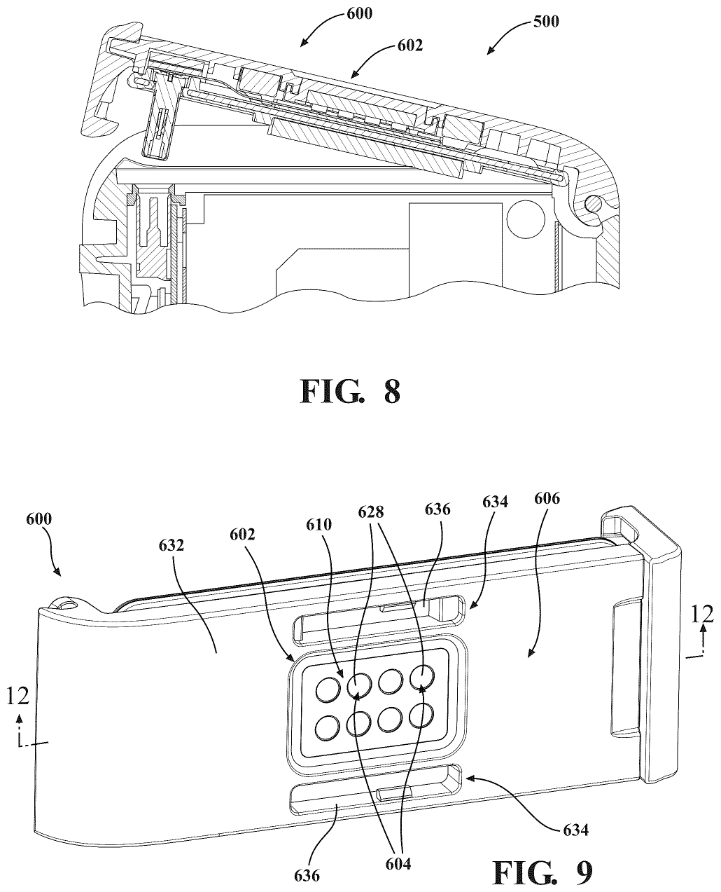

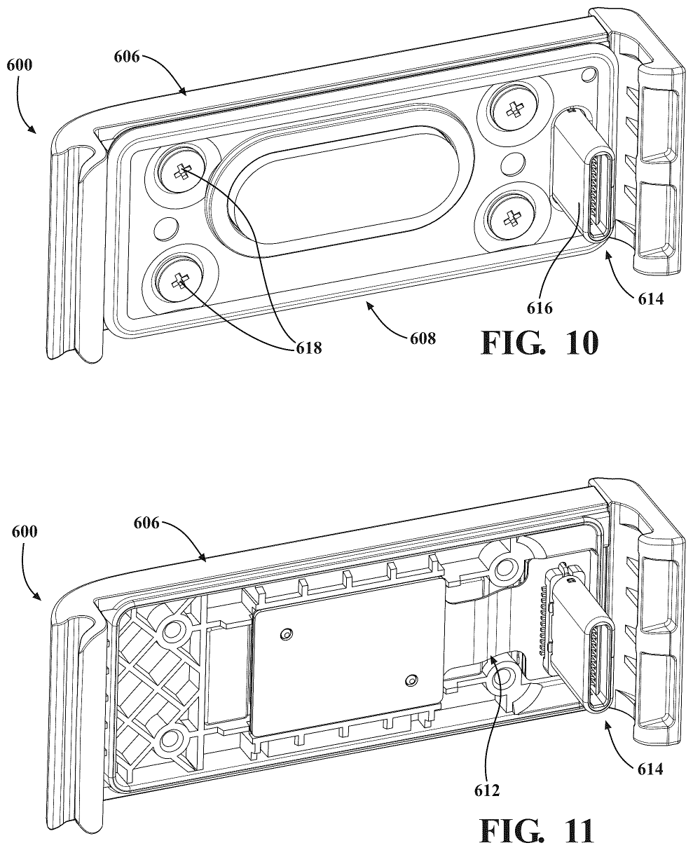

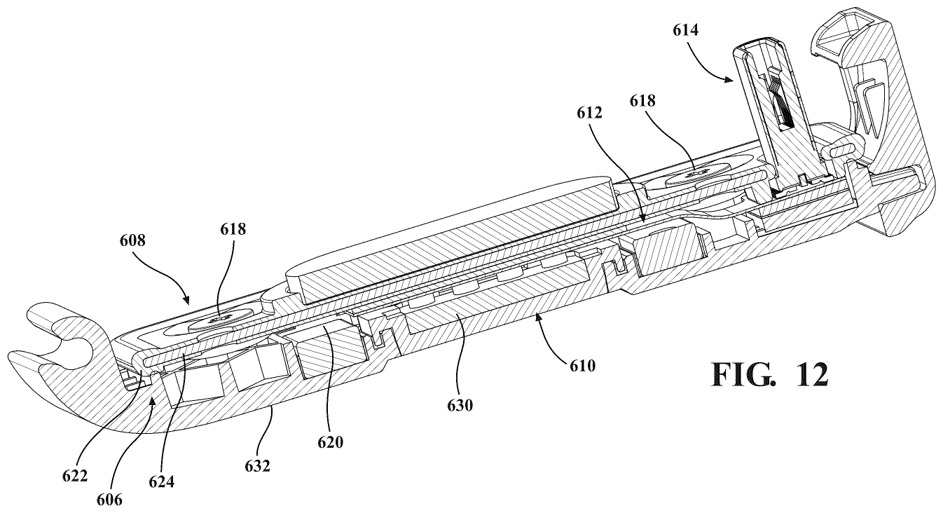

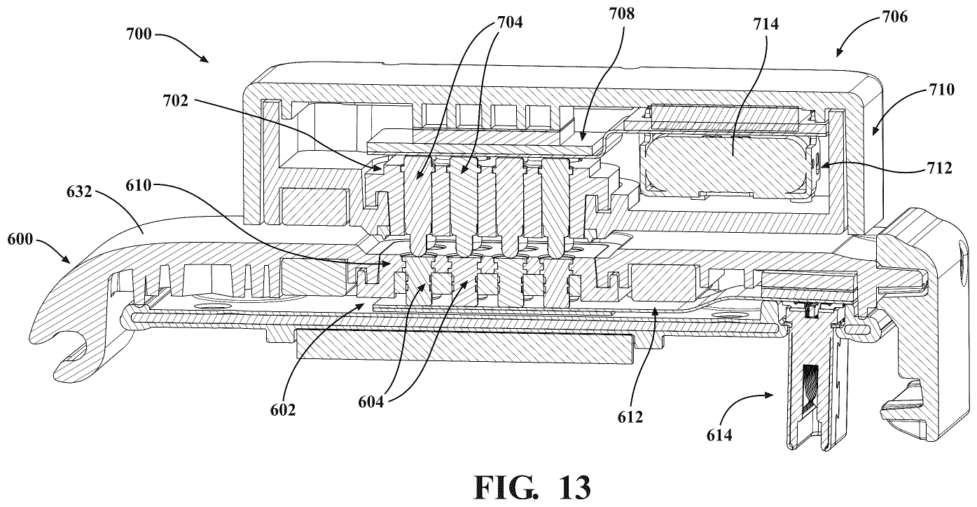

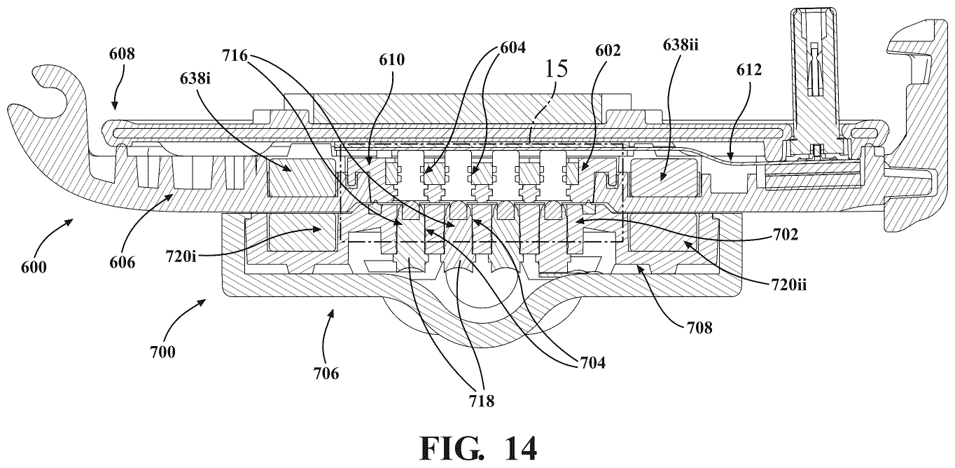

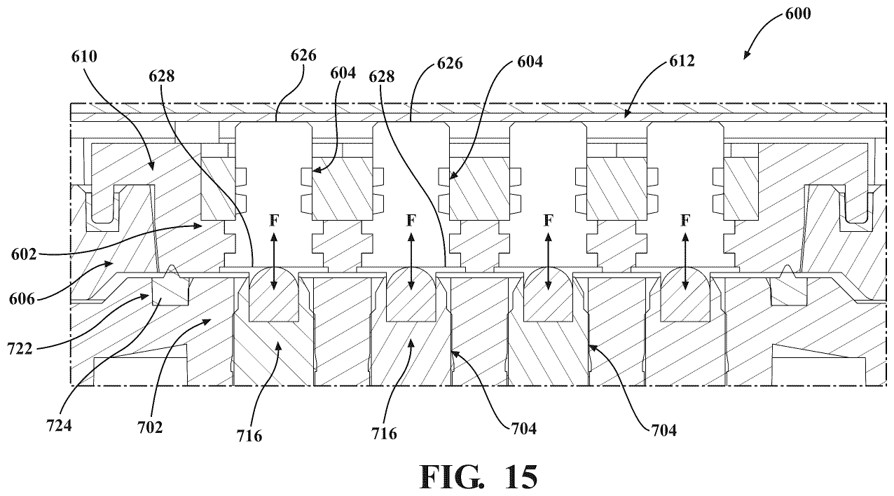

With reference now to FIGS. 8-15, the door 600 and the external accessory 700 will be discussed. More specifically, FIG. 8 is a partial, cross-sectional view of the image capture apparatus 500 with the door 600 shown in an open position; FIG. 9 is an outer, perspective view of the door 600 shown separated from the image capture apparatus 500; FIG. 10 is an inner, perspective view of the door 600 shown separated from the image capture apparatus 500; FIG. 11 is a partial, inner, perspective view of the door 600 shown separated from the image capture apparatus 500; FIG. 12 is an axial (longitudinal, vertical) cross-sectional view of the door 600 taken along line 12-12 in FIG. 9 and shown in perspective; FIG. 13 is a partial, axial (longitudinal, vertical) cross-sectional view of the door 600 and the external accessory 700 taken along line 13-13 in FIG. 6 and shown in perspective; FIG. 14 is an axial (longitudinal, vertical) cross-sectional view of the door 600 and the external accessory 700; and FIG. 15 is an enlargement of the area of detail identified in FIG. 14.

The door 600 and the external accessory 700 include respective corresponding (first and second) electrical interfaces 602, 702 that are configured for (electrical) connection such that power and/or data are transmission between the image capture apparatus 500 and the external accessory 700. For example, it is envisioned that the electrical interfaces 602, 702 may be configured such that power and/or data are transmittable (deliverable) from the external accessory 700 to the image capture apparatus 500 and/or such that power and/or data are transmittable (deliverable) from the image capture apparatus 500 to the external accessory 700. As described in further detail below, the electrical interface 602 is integrated into to the door 600, which allows for connection of the external accessory 700 to the image capture apparatus 500 while the door 600 is in the closed position (FIG. 5), thereby eliminating any need to reposition (or otherwise manipulate) the door 600 in order to establish electrical communication and, thus the transmission of power and/or data, between the image capture apparatus 500 and the external accessory 700.

In the illustrated embodiment, the door 600 includes eight connector (electrical) pads 604 (FIGS. 5, 9, 12-15), which provide the electrical interface 602, and the external accessory 700 includes eight connector (electrical) pins 704 (FIGS. 13-15), which provide the electrical interface 702 and that are configured for contact with the connector pads 604 in order to establish an electrical connection between the image capture apparatus 500 and the external accessory 700. It should be appreciated, however, that the particular number and/or the particular configurations of the pads 604 and/or the connector pins 704 may be varied in alternate embodiments without departing from the scope of the present disclosure (e.g., depending upon the particular power and/or data requirements of the image capture apparatus 500).

It is envisioned that the connector pads 604 and the connector pins 704 may include (e.g., may be formed partially or entirely from) any material or combination of electrically conductive materials suitable for the intended purpose of facilitating the transmission of power and/or data between the image capture apparatus 500 and the external accessory 700 in the manner described herein.

With reference to FIGS. 8-12 in particular, in addition to the electrical interface 602, the door 600 includes: a door body 606; a sealing member 608; a carrier (frame) 610 (FIG. 12); a flexible printed circuit (FPC) assembly 612; and a receptacle 614 (e.g., a USB receptacle 616).

The sealing member 608 is supported by (e.g., secured, connected to) the door body 606, and is configured to form a (watertight) seal with both a body 502 of the image capture apparatus 500 (e.g., upon closure of the door 600) and the door body 606. More specifically, the sealing member 608 is secured to the door body 606 via one or more mechanical fasteners 618 (FIGS. 10, 12) (e.g., screws, pins, etc.) such that the sealing member 608 engages the door body 606 so as to define a (watertight) internal chamber 620 (FIG. 12) that receives the electrical interface 602 (i.e., the connector pads 604), which inhibits (if not entirely prevents) the entry of water into the body 502 of the image capture apparatus 500 through the door 600.

In the illustrated embodiment, the sealing member 608 includes an outer layer 622 (FIG. 12) that is formed from a (first) compressible material (e.g., silicone rubber), and an inner layer (core) 624 that is formed from a (second) material (e.g., a metallic material, polycarbonate, etc.) to increase rigidity and stability of the sealing member 608 and the door 600. It should be appreciated, however, that, the sealing member 608 may be configured in any manner suitable for the intended purpose of forming the aforementioned seals with the body 502 of the image capture apparatus 500 and the door body 606, and that the material(s) used in construction of the sealing member 608 may be varied. For example, an embodiment in which the sealing member 608 may include (e.g., may be formed from) a single material only are also envisioned herein and would not be beyond the scope of the present disclosure.

The carrier 610 is (adhesively and/or mechanically) secured (connected) to the door body 606 (e.g., within the internal chamber 620), which integrates the electrical interface 602 into construction of the door body 606, and supports the connector pads 604 such that the connector pads 604 extend therethrough. More specifically, the connector pads 604 each include first ends 626 (FIG. 15), which are positioned (located) within the door body 606 and are in electrical communication (e.g., contact) with the FPC assembly 612, and second ends 628 (FIGS. 9, 15) which extend through the carrier 610 and are exposed from the door body 606 so as to facilitate connection to (engagement, contact with) the external accessory 700 (e.g., via the electrical interface 702). In order to secure the connector pads 604 within the carrier 610 and/or further seal the internal chamber 620, it is envisioned that an adhesive 630 (FIG. 12) may be utilized.

As seen in FIGS. 5 and 9, the electrical interface 602 (i.e., the connector pads 604) are recessed into the door body 606 so as not to extend beyond an outermost (exterior) surface 632 thereof. More specifically, the door 600 is configured such that the second ends 628 of the connector pads 604 are spaced laterally inward of the outermost surface 632 of the door body 606, which inhibits (if not entirely prevents) inadvertent contact with external objects. In order to guard against deterioration, it is envisioned that the connector pads 604 may include (e.g., may be formed partially or entirely from) one or more corrosion-resistant materials and/or that a corrosion-resistant coating may be applied to the connector pads 604.

The FPC assembly 612 is positioned (located) between the sealing member 608 and the carrier 610 and is supported by (e.g., secured, connected to) the door body 606 such that the FPC assembly 612 is in electrical communication with the connector pads 604 and the receptacle 614 and extends therebetween. The FPC 612 thus facilitates the transmission of power and/or data from the electrical interface 602 to the receptacle 614.

It is envisioned that the FPC assembly 612 may be supported by the door body 606 in any suitable manner. For example, it is envisioned that the FPC assembly 612 may be adhesively and/or mechanically connected to the sealing member 608, to the carrier 610, or to any other suitable component of the door body 606.

The receptacle 614 is supported by (e.g., secured, connected to) the door body 606 and is configured to interface with (connect to, engage) a power source (i.e., the battery) in the image capture apparatus 500 (e.g., via the battery receptacle 126 (FIG. 1B)) in order to facilitate the transmission of power and/or data between the image capture apparatus 500 and the external accessory 700 (e.g., upon closure of the door 600). More specifically, in the illustrated embodiment, the receptacle 614 is indirectly supported by the door body 606 and is secured (connected) to the FPC assembly 612 such that the receptacle 614 extends through the sealing member 608, as seen in FIGS. 10 and 11, for example.

With reference now to FIGS. 13-15 in particular, the external accessory 700 will be discussed. In addition to the electrical interface 702, the external accessory 700 includes: a chassis 706 and a printed circuit board (PCB) assembly 708, which is supported by (e.g., secured, connected to) the chassis 706 in any suitable manner (e.g., via an adhesive, via a mechanical connection, etc.).

The chassis 706 receives (accommodates) the electrical interface 702 and the PCB assembly 708, and provides a housing 710 for the external accessory 700.

The PCB assembly 708 supports the connector pins 704 and is in electrical communication therewith so as to facilitate the transmission of power and/or data between the PCB assembly 708 and the connector pins 704. It is envisioned that the chassis 706 and the connector pins 704 may be secured (connected) together in any suitable manner such as, for example, via an adhesive, via soldering or brazing, etc.

In certain embodiments, it is envisioned that the external accessory 700 may further include a receptacle 712 (e.g., a USB receptacle 714), as seen in FIG. 13, that is in electrical communication with the PCB assembly 708 so as to facilitate the transmission of power and/or data into the external accessory 700. Additionally, or alternatively, it is envisioned that the external accessory 700 may include a power source (e.g., a battery) that is in electrical communication with the PCB assembly 708 such that the external accessory 700 is operable as a power station for the image capture apparatus 500.

As seen in FIGS. 13 and 14, the connector pins 704 are configured to interface with connector pads 604 such that power and/or data is transmittable from the electrical interface 702 to the electrical interface 602. More specifically, power and/or data is transmitted from the PCB assembly 708 to the connector pins 704, which is transmitted to the connector pads 604 via the electrical connection established therebetween upon connection of the external accessory 700 to the image capture apparatus 500 (e.g., via contact between the electrical interfaces 602, 702). The power and/or data transmitted to the connector pads 604 is then communicated to the FPC assembly 612, which routes the power and/or data to the receptacle 614, which pairs (mates) with the image capture apparatus 500 (e.g., via the battery receptacle 126 (FIG. 1B)) to thereby deliver the power and/or data thereto.

In order to allow for minor misalignments and maintain connection between the external accessory 700 and the image capture apparatus 500 (e.g., the door 600) during dynamic use cases, the connector pins 704 are resiliently reconfigurable between an expanded (normal, initial) configuration (FIG. 13) and a collapsed (active, subsequent) configuration (FIGS. 14, 15). For example, it is envisioned that the connector pins 704 may include internal biasing members 716 (FIGS. 14, 15) (e.g., springs 718) that are configured to bias (urge) the connector pins 704 towards the expanded configuration. In such embodiments, upon connection of the external accessory 700 to the image capture apparatus 500, the connector pins 704 are compressed against the connector pads 604, which reconfigures the connector pins 704 from the expanded configuration into the collapsed configuration. Reconfiguration of the connector pins 704 into the collapsed configuration generates a biasing force F (FIG. 15) that is applied between the external accessory 700 and the image capture apparatus 500.

In order to resist and overcome the biasing force F and facilitate proper connection (engagement) and alignment (registration) of the image capture apparatus 500 (e.g., the door 600) and the external accessory 700, the door 600 and the external accessory 700 include corresponding magnetic members 638i, 638ii (FIG. 14) and 720i, 720ii, respectively. More specifically, in the illustrated embodiment, the magnetic members 638i, 720i and the magnetic members 638ii, 720ii include opposing polarities such that the external accessory 700 is connectable to (engageable with) the image capture apparatus 500 in a single orientation only.

Upon connection of the external accessory 700 to the image capture apparatus 500, with the biasing force F being overcome, the magnetic members 638, 720, the connector pins 704, and the connector pads 604 cooperatively maintain the electrical connection between the electrical interfaces 602, 702 by preserving contact between the connector pins 704 and the connector pads 604. The magnetic members 638, 720, the connector pins 704, and the connector pads 604 thus accommodate relative movement between the image capture apparatus 500 and the external accessory 700 while maintaining the electrical connection therebetween in the event of an applied external force (e.g., should the image capture apparatus 500 and the external accessory 700 be dropped, come into contact with an external object, etc.).

In the illustrated embodiment, whereas the electrical interface 702 (i.e., the connector pins 704) includes a dynamic (non-fixed, variable) configuration, the electrical interface 602 (i.e., the connector pads 604) includes a static (e.g., fixed) configuration. Embodiments in which the electrical interface 702 may include a static configuration and the electrical interface 602 may include a dynamic configuration are also envisioned herein, however. For example, an embodiment in which the electrical interfaces 602, 702 may respectively include the connector pins 704 and the connector pads 604 would not be beyond the scope of the present disclosure.

In order to facilitate continued performance in the presence of water, moisture, etc., it is envisioned that the external accessory 700 may include a sealing member 722 (FIG. 15) (e.g., a gasket 724) that is configured for engagement (contact) with the door 600. For example, it is envisioned that the sealing member 722 may be configured for engagement with the door body 606 and/or the carrier 610 such that, upon connection of the external accessory 700 to the door 600, the sealing member 722 forms a watertight seal therebetween that extends about and conceals the electrical interface 602 (i.e., the connector pads 604) and the electrical interface 702 (i.e., the connector pins 704).

In certain embodiments, it is envisioned that the door 600 and the external accessory 700 may include corresponding alignment members in order to facilitate proper alignment (registration) and engagement of the image capture apparatus 500 and the external accessory 700. For example, it is envisioned that the door body 606 may include at least one (one or more) recesses 634 (FIGS. 5, 9) (e.g., channels 636) that are configured to receive at least one (one or more) corresponding projections (e.g., ribs) (not shown) on the external accessory 700 to create a mechanical interface therebetween. Embodiments in which the configurations of the alignment members may be reversed (e.g., embodiments in which the door body 606 may include the projection(s) and the external accessory 700 may include the recess(es) 634) are also envisioned herein, however, and would not be beyond the scope of the present disclosure.

While the present disclosure has been described in connection with certain embodiments, it is to be understood that the present disclosure is not to be limited to the disclosed embodiments, but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “generally,” “approximately,” “substantially,” and the like should be understood to include the numerical range, concept, or base term with which they are associated as well as variations in the numerical range, concept, or base term on the order of up to 25% (e.g., to allow for manufacturing tolerances and/or deviations in design). For example, the term “generally parallel” should be understood as referring to an arrangement in which the pertinent components (structures, elements) subtend an angle therebetween that is equal to 180° as well as an arrangement in which the pertinent components (structures, elements) subtend an angle therebetween that is greater than or less than 180° (e.g., ±10%, ±15%, ±25%). The term “generally parallel” should thus be understood as encompassing configurations in which the pertinent components are arranged in parallel relation. Similarly, the term “generally identical” should be understood as encompassing configurations in which the pertinent components are identical in configuration as well as configurations in which there may be insubstantial variations between the pertinent components that do not influence the substantive construction or performance thereof.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure, etc.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An image capture system comprising:
an image capture apparatus including:
a body; and
a door coupled to the body, wherein the door includes:
a door body;
a carrier supported by the door body;
connector pads supported by the carrier;
a flexible printed circuit (FPC) assembly supported by the door body and in electrical communication with the connector pads; and
a receptacle supported by the door body, wherein the receptacle is in electrical communication with the FPC assembly and is configured to interface with a power source of the image capture apparatus; and
an external accessory configured for electrical connection to the image capture apparatus, wherein the external accessory includes:
a chassis;
a printed circuit board (PCB) assembly supported by the chassis; and
connector pins supported by the PCB assembly and configured for contact with the connector pads so as to electrically connect the image capture apparatus and the external accessory, thereby eliminating any need to reposition the door to transmit power and/or data between the image capture apparatus and the external accessory.

2. The image capture system of claim 1, wherein the connector pads extend through the carrier.

3. The image capture system of claim 1, wherein the connector pads include:
first ends positioned within the door body and in electrical communication with the FPC assembly; and
second ends exposed from the door body to facilitate contact with the connector pins.

4. The image capture system of claim 3, wherein the connector pads are recessed into the door body so as not to extend beyond an outermost surface thereof.

5. The image capture system of claim 1, wherein the connector pins are resiliently reconfigurable between an expanded configuration and a collapsed configuration.

6. The image capture system of claim 5, wherein the connector pins are biased towards the expanded configuration.

7. The image capture system of claim 1, wherein the door further includes:
a sealing member supported by the door body so as to define a watertight internal chamber for the connector pads.

8. The image capture system of claim 1, wherein the external accessory further includes:
a receptacle in electrical communication with the PCB assembly to facilitate power and/or data communication into the external accessory.

9. The image capture system of claim 1, wherein the external accessory further includes:
a sealing member configured for engagement with the door such that, upon connection of the external accessory and the image capture apparatus, a watertight seal is formed therebetween extending about the connector pads and the connector pins.

10. The image capture system of claim 1, wherein the door and the external accessory include corresponding magnetic members to facilitate proper alignment thereof.

11. An image capture system comprising:
an image capture apparatus including:
a body; and
a door coupled to the body and including a first electrical interface; and
an external accessory configured for electrical connection to the image capture apparatus and including a second electrical interface, wherein the first electrical interface and the second electrical interface are configured for contact to facilitate power and/or data transmission between the image capture apparatus and the external accessory.

12. The image capture system of claim 11, wherein the first electrical interface includes a dynamic configuration, and the second electrical interface includes a static configuration.

13. The image capture system of claim 11, wherein the first electrical interface includes a static configuration, and the second electrical interface includes a dynamic configuration.

14. The image capture system of claim 13, wherein the second electrical interface is reconfigurable between an expanded configuration and a collapsed configuration.

15. The image capture system of claim 14, wherein the second electrical interface is biased towards the expanded configuration.

16. An image capture apparatus including:
a body; and
a door coupled to the body, wherein the door includes an electrical interface configured for connection to an external accessory to facilitate power and/or data transmission between the image capture apparatus and the external accessory.

17. The image capture apparatus of claim 16, wherein the door further includes:
a door body; and
connector pads supported by the door body, wherein the connector pads include:
first ends positioned within the door body; and
second ends exposed from the door body to facilitate connection to the external accessory.

18. The image capture apparatus of claim 17, wherein the connector pads are recessed into the door body so as not to extend beyond an outermost surface thereof.

19. The image capture apparatus of claim 17, wherein the door further includes:
a flexible printed circuit (FPC) assembly supported by the door body and in electrical communication with the first ends of the connector pads.

20. The image capture apparatus of claim 19, wherein the door further includes:
a receptacle supported by the door body and configured to interface with a power source of the image capture apparatus, wherein the receptacle is in electrical communication with the FPC assembly.
